(19) United States
(12) Patent Application Publication
(10) Pub. No.: US 2016/0148250 A1
(43) Pub. Date: May 26, 2016

(54) Searching for Safe Policies to Deploy

(71) Applicant: Adobe Systems Incorporated, San Jose, CA (US)

(72) Inventors: Philip S. Thomas, Chicopee, MA (US); Georgios Theocharous, San Jose, CA (US); Mohammad Ghavamzadeh, San Jose, CA (US)

(21) Appl. No.: 14/551,975

(22) Filed: Nov. 24, 2014

(51) Int. Cl. G06Q 30/02

(52) U.S. Cl. CPC G06Q 30/0244

(57) ABSTRACT

Risk quantification, policy search, and automated safe policy deployment techniques are described. In one or more implementations, techniques are utilized to determine safety of a policy, such as to express a level of confidence that a new policy will exhibit an increased measure of performance (e.g., interactions or conversions) over a currently deployed policy. In order to make this determination, reinforcement learning and concentration inequalities are utilized, which generate and bound confidence values regarding the measurement of performance of the policy and thus provide a statistical guarantee of this performance. These techniques are usable to quantify risk in deployment of a policy, select a policy for deployment based on estimated performance and a confidence level in this estimate (e.g., which may include use of a policy space to reduce an amount of data processed), used to create a new policy through iteration in which parameters of a policy are iteratively adjusted and an effect of those adjustments are evaluated, and so forth.

### BACKGROUND

Users are exposed to an ever increasing variety of content, such as webpages via the Internet. One technique that is used to monetize provision of this content by content providers is through inclusion of advertisements. For example, a user may access a webpage that includes a variety of advertisements and may select (e.g., “click”) an advertisement of interest to gain additional information about a good or service referenced in the advertisement. Accordingly, providers of the good or service may provide compensation to the content provider for inclusion of the advertisements as well as for selections of the advertisement by potential consumers.

Policies may be used in order to choose which advertisements are to be shown to particular users or groups of users. For example, data may be collected that describes a user, the user's interaction with content, and so on. This data may then be used by policies to determine which advertisements are to be shown to the user, such as to increase a likelihood that the user will select one or more of the included advertisements. However, conventional techniques that are utilized to select policies for deployment did not have a mechanism for guaranteeing that a newly selected policy will perform better than a current policy.

For example, conventional solutions exist, called “off-policy evaluation techniques,” for estimating the performance of a policy. However, these conventional off-policy evaluation techniques do not, in any way, bound or describe the accuracy of this evaluation. For example, these existing techniques do not provide knowledge of the chance that the new policy is actually worse than a deployed policy. Consequently, these conventional techniques could expose to potential loss of revenue and inefficiency from ill-performing policies.

### SUMMARY

Risk quantification, policy search, and automated safe policy deployment techniques are described. In one or more implementations, techniques are utilized to determine safety of a policy, such as to express a level of confidence that a new policy will exhibit an increased measure of performance (e.g., interactions or conversions) over a currently deployed policy. In order to make this determination, reinforcement learning and concentration inequalities are employed, which generate and bound confidence values regarding the measurement of performance of the policy and thus provide a statistical guarantee of this performance. These techniques are usable to quantify risk in deployment of a policy, select a policy for deployment based on estimated performance and a confidence level in this estimate (e.g., which may include use of a policy space to reduce an amount of data processed), used to create a new policy through iteration in which parameters of a policy are iteratively adjusted and an effect of those adjustments are evaluated, and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a system in an example implementation in which a reinforcement learning module is shown in greater detail.

FIG. 3A depicts a graph showing performance of a policy and confidence.

FIG. 3B includes a curve that provides an empirical estimate of a probability density function.

FIG. 4 depicts a table depicting results of different concentration inequality functions.

FIG. 5 depicts an example of a determination of safety of policy parameters.

FIG. 6 depicts an example of pseudo code of Algorithm 1 in the following.

FIG. 7 depicts an example of pseudo code of Algorithm 2 in the following.

FIG. 8 depicts an example of pseudo code of Algorithm 3 in the following.

FIG. 9 is a flow diagram depicting a procedure in an example implementation in which techniques involving risk quantification for policy improvement are described.

FIG. 10 is a flow diagram depicting a procedure in an example implementation in which control of replacement of one or more deployed policies involving a policy search is described.

FIG. 11 is a flow diagram depicting a procedure in an example implementation in which selection of policies to replace deployed policies is performed by leveraging a policy space to improve efficiency.

FIG. 12 is a flow diagram depicting a procedure in an example implementation in which new policies are generated iteratively and used to replace deployed policies.

FIG. 13 shows results of performing policy improvement techniques and Algorithm 3.

FIG. 14 presents example results compared to performance of NAC with manually optimized hyper-parameters.

FIG. 15 depicts results of an application of Algorithm 3.

FIG. 16 illustrates an example system including various components of an example device that can be implemented as any type of computing device as described and/or utilize with reference to FIGS. 1-15 to implement embodiments of the techniques described herein.

### DETAILED DESCRIPTION

### Overview

Policies are employed to determine which advertisements to select for inclusion with content that is to be sent to particular users. For example, a user may access a content provider via a network to obtain content, such as through use of a browser to obtain a particular webpage. This access is used by the content provider to identify characteristics related to this access, such as characteristics of the user (e.g., demographics) as well as characteristics of the access itself, e.g., time of day, geographic location, and so on. These characteristics are processed by the content provider using the policy to determine which advertisements are to be selected for inclusion with the webpage that is communicated back to the user. Accordingly, the policy may be used to select different advertisements for inclusion with the content based on different characteristics of this access.

Conventional techniques that are employed to deploy policies, however, do not have a mechanism for bounding or quantifying accuracy of whether a new policy will perform better than a currently deployed policy. Because of this, these conventional techniques often force users to make a best guess as to whether this new policy will have better performance, e.g., result in an increased number of selections of the advertisement, result in an increased number of conversions in which the user purchased the good or service, and so on.

Accordingly, techniques are described in which risk for deployment of a policy is quantifiable, which is utilized to support a variety of functionality. For example, data describing deployment of existing policies is accessed and processed to determine whether the new policy will exhibit increased performance over the existing policies. This is performed through calculation of confidence values that express the confidence that performance of the new policy will meet at least a defined value (e.g., which may be based on performance of the deployed policy) and thus act as a statistical guarantee of this performance.

In order to calculate the statistical guarantee, a concentration inequality is utilized as a part of reinforcement learning in the following. Reinforcement learning is a type of machine learning in which software agents are executed to take actions in an environment to maximize some notion of a cumulative award. In this example, the reward is to maximize performance of a policy to select advertisements such as to increase a number of selections of an advertisement (e.g., “clicks”), conversions of the advertisement (e.g., resulted in “buys”), and so forth.

The concentration inequality is employed as part of reinforcement learning to insure safety that the new policy exhibits performance of at least an amount of the deployed policy. The concentration inequality, for instance, is utilized to address deviations of functions of independent random variables from their expectations. Thus, the concentration inequality provides a bound to these distributions and ensure accuracy of a result. For example, the concentration inequality may bound values such that values that exist above a threshold are moved to lie at the threshold, may be used to collapse tails of the distributions, and so forth as further described below.

In the following, a concentration inequality is first presented in Algorithm 1, which allows an efficient determination as to whether a policy is safe for deployment and thus selection of advertisements without a decrease in performance. Second, a safe batch reinforcement learning algorithm is presented in Algorithm 2 that is configured to leverage reinforcement learning and concentration inequalities to select a policy for deployment. Third, a safe iterative algorithm is presented in Algorithm 3 that is configured to generate a new policy through iterative adjustment of parameters and analysis using reinforcement learning and concentration inequalities to determine when these adjustments are likely to result in increased performance. Even though Algorithm 3 ensures safety, it has reasonable sample efficiency compared to a state-of-the-art heavily-tuned non-safe algorithm as further described below through use of a policy space.

An example environment is first described that may employ the techniques described herein. Example procedures and implementation examples are then described which may be performed in the example environment as well as other environments. Consequently, performance of the example procedures is not limited to the example environment and implementation examples and the example environment is not limited to performance of the example procedures.

Example Environment

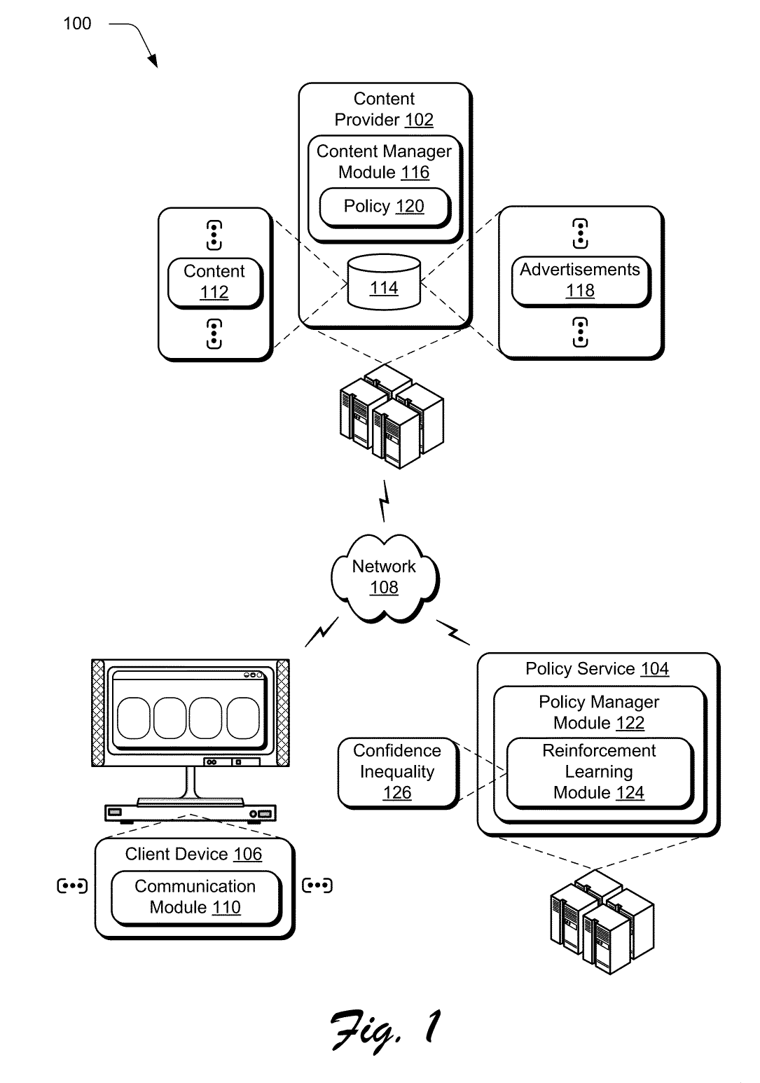

FIG. 1 is an illustration of an environment 100 in an example implementation that is operable to employ reinforcement learning and concentration inequality techniques described herein. The illustrated environment 100 includes a content provider 102, a policy service 104, and a client device 106 that are communicatively coupled, one to another, via a network 108. Computing devices that implement these entities may be configured in a variety of ways.

A computing device, for instance, is configurable as a desktop computer, a laptop computer, a mobile device (e.g., assuming a handheld configuration such as a tablet or mobile phone), and so forth. Thus, the computing device includes a range from full resource devices with substantial memory and processor resources (e.g., personal computers, game consoles) to a low-resource device with limited memory and/or processing resources (e.g., mobile devices). Additionally, although a single computing device is shown, the computing device is also representative of a plurality of different devices, such as multiple servers utilized by a business to perform operations “over the cloud” as shown for the content provider 102 and the policy service 104 and as further described in relation to FIG. 16.

The client device 106 is illustrated as including a communication module 110, which is representative of functionality to access content 112 via the network 108. The communication module 110, for instance, is configurable as a browser, a network-enabled application, third-party plugin, and so on. As such, the communication module 110 has access to a variety of different content 112 of the content provider 102 via the network 108, which is illustrated as stored in storage 114. The content 112 may be configured in a variety of ways, such as web pages, images, music, multimedia files, and so on.

The content provider 102 includes a content manager module 116 that is representative of functionality to manage provision of the content 112, including which advertisements 118 are to be included along with the content 112. In order to determine which advertisements 118 are to be included with the content 112, the content manager module 116 employs a policy 120.

When a user navigates to a content 112 such as a webpage, for instance, a list containing known attributes of that user is formed as a feature vector in which values of the feature vector reflect a current state or observations of the user. For example, the values of the feature vector can describe characteristics of a user that initiated access to the content 112 (e.g., demographics such as age and gender) and/or how that access is performed, such as characteristics of the client device 106 or network 108 used to perform the access, characteristics of the access itself such as time of day, day of week, what lead to this access (e.g., selection of a link on a webpage), and so forth.

Accordingly, the feature vector is configured as an n-dimensional vector of numerical features that represent attributes of the user and access that have been observed. In the following, the policy 120 causes performance of an action based on a decision involving the observed current state of the user, e.g., as expressed by the feature vector above. For example, the content manager module 116 first observes a state of the user and then decides which action to take using the policy 120. In the illustrated case, the possible actions are which advertisements 118 are selected for display by the client device 106. So, if there are ten possible advertisements, then there are ten possible actions in this example.

Performance of the policy 120 is measurable in a variety of ways. For example, performance is definable as a measure of user interaction (e.g., how often a user has “clicked”) with advertisement 118, and thus the higher the better in the following discussion. In another example, performance is definable as a conversion rate of the advertisement 118, e.g., purchases of goods or services made following selection of the advertisements 118, and thus higher is also better in this example. It should be noted that different policies may have different performances. Some policies, for instance, might result in high click-rates on the advertisements, while others might not. In the end, the goal in this example is to deploy a policy 120 that has the best possible performance, i.e., supports the highest interaction, conversion, and so on.

In order to ensure that a safe policy is deployed that exhibits at least a defined level of performance (e.g., at least equal to performance of a deployed policy along with a defined margin), the policy service 104 utilizes a policy manager module 122. The policy manager module 122 is representative of functionality to generate the policy 120 and/or compute a statistic guarantee to ensure that the policy 120 is safe for deployment, e.g., exhibits at least a level of performance of a previously deployed policy.

An example of this functionality is illustrated as a reinforcement learning module 124 that is used to employ reinforcement learning techniques to guarantee that deployment of a new policy will improve upon a current policy being used, i.e., a deployed policy. Reinforcement learning is a type of machine learning in which software agents are executed to take actions in an environment to maximize some notion of a cumulative award, which in this case is to maximize performance of a policy 120 to select advertisements 118 that result in user interaction (e.g., clicks) or conversions of related goods or services.

For example, the reinforcement learning module 124 uses reinforcement learning to generate confidence values that a new policy will exhibit increased performance over a deployed policy and thus provide a statistical guarantee of this increased performance. The confidence values are generated in a variety of ways, such as through use of deployment data that describes deployment of a previous policy (i.e., existing or current policy) by the content provider 102. The reinforcement learning module 124 then processes this deployment data using the new policy to compute the statistical guarantee and as such, may do so without actual deployment of the new policy. In this way, the content provider 102 is protected from deployment of a potentially bad policy that could result in decreased revenue through lower interactions and/or conversions.

As part of the computation of the statistical guarantee, the reinforcement learning module 124 uses a confidence inequality 126, such as to ensure “safety” that the new policy exhibits performance of at least an amount of the deployed policy. The concentration inequality is utilized to address deviations of functions of confidence values of the statistical guarantee from their expectations, i.e., the expected values. This is utilized to bound the distributions of the concentration values and thus improve accuracy of the statistical guarantee. For example, the concentration inequality may bound confidence values such that confidence values that exist above a threshold are moved to lie at the threshold, may be used to collapse tails of the distributions, and so forth. Further discussion of concentration inequalities and reinforcement learning are described in the following.

As such, reinforcement learning is utilized in the following to support a variety of different functionality related to selection and generation of a policy 120 for use in selection of advertisements or other functionality. For example, reinforcement learning and concentration equalities are used to quantify an amount of risk involved in deployment of a new policy based on deployment data of previous policies through use of statistical guarantees. In another example, reinforcement learning and concentration equalities are used to select which of a plurality of policies, if any, are to be deployed to replace a current policy. In a further example, reinforcement learning and concentration equalities are used to generate a new policy through an iterative technique that involves adjustment of parameters of a policy and computation of statistical guarantees using deployment data. Further discussion of these and other examples are described in the following and shown in corresponding figures.

Although selection of advertisements is described in the following, the techniques described herein may be utilized for a variety of different types of policies. Example of other policy uses include lifetime value optimization in marketing systems, news recommendation systems, patient diagnosis systems, neuro-prosthetic control, automatic drug administration, and many more.

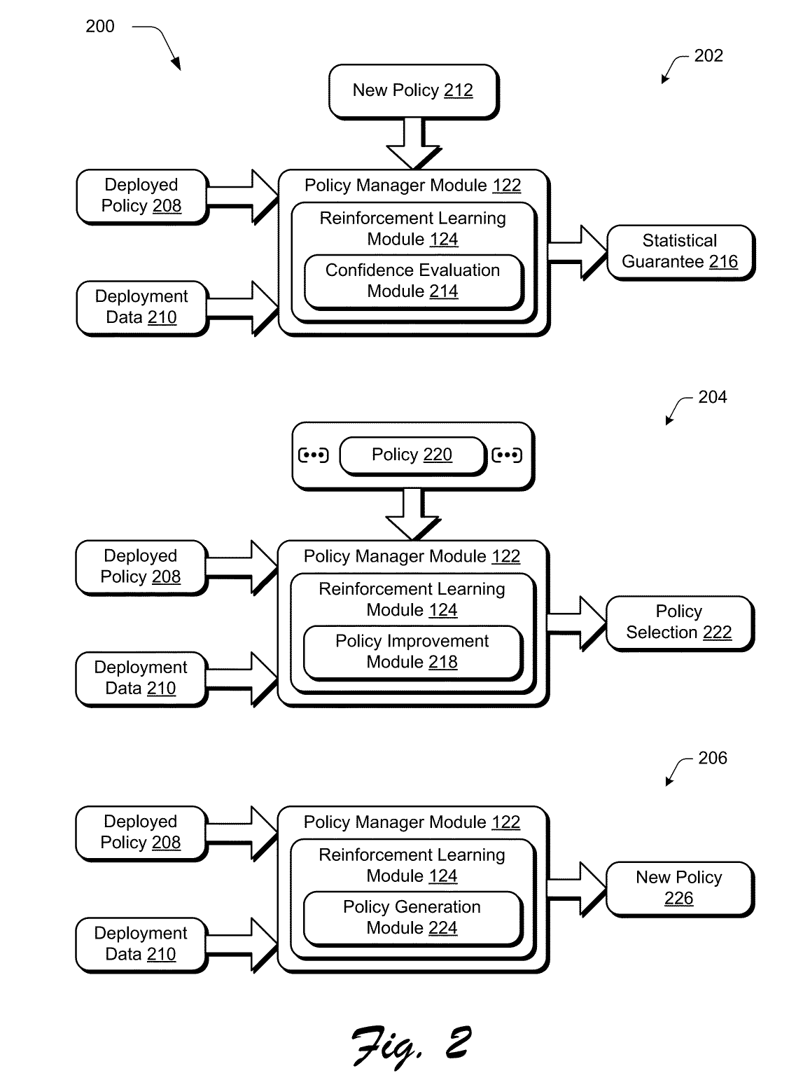

FIG. 2 depicts a system 200 in an example implementation in which the reinforcement learning module 124 is shown in greater detail. The system 200 is illustrated as including first, second, and third examples 202, 204, 206. In the first example, a deployed policy 208 is used to select advertisements 118 for inclusion with content 112 that is communicated to a user of a client device 106 as previously described, e.g., webpages. Accordingly, deployment data 210 is collected by the policy manager module 122 that describes the deployment of the deployed policy 208 by the content provider 102.

The policy manager module 112, in this instance, also proposes a new policy 212 for use in replacing the deployed policy 208. The policy manager module 122 then utilizes the reinforcement learning module 124 to determine whether to deploy the new policy 212, which includes use of concentration inequalities 126 as described in relation to FIG. 1 to increase accuracy of a statistic guarantee of likely performance of the new policy. If the new policy 212 is “bad” (e.g., has a lower performance score than the deployed policy 208), deployment of the new policy 212 may be costly, e.g., due to lost user interactions, conversions, and other performance measures as described above.

In order to perform this determination, the policy manager module 122 accesses the deployment data 210 that describes use of the deployed policy 208 by the content provider 102 of FIG. 1. This access is used to predict whether to deploy the new policy 212 based on confidence that the new policy 212 has better performance than the deployed policy 208. In this way, this prediction is performed without actual deployment of the new policy 212.

In the illustrated example, the reinforcement learning module 124 includes a confidence evaluation module 214 that is representative of functionality to generate a statistical guarantee 216, an example of which is described as Algorithm 1 and “IsSafe” in the following. The statistical guarantee 216, through use of the concentration inequalities, is used to quantify risk of deployment of the new policy 212 using confidence values computed for the new policy 212 based on the deployment data 210 that are bound by the concentration inequalities 126 of FIG. 1. This improves accuracy over conventional techniques. So, unlike conventional techniques, the statistical guarantee 216 indicates an amount of confidence that the estimates expressed by the confidence values learned by the reinforcement learning module 124 are correct. For example, given the deployed policy 208, deployment data 210 from deployment of the deployed policy 208, and performance level “ƒₘᵢₙ”, the confidence that the new policies 212 performance is at a level of at least “ƒₘᵢₙ” is expressed by the statistical guarantee 216 that defines accuracy of the estimate.

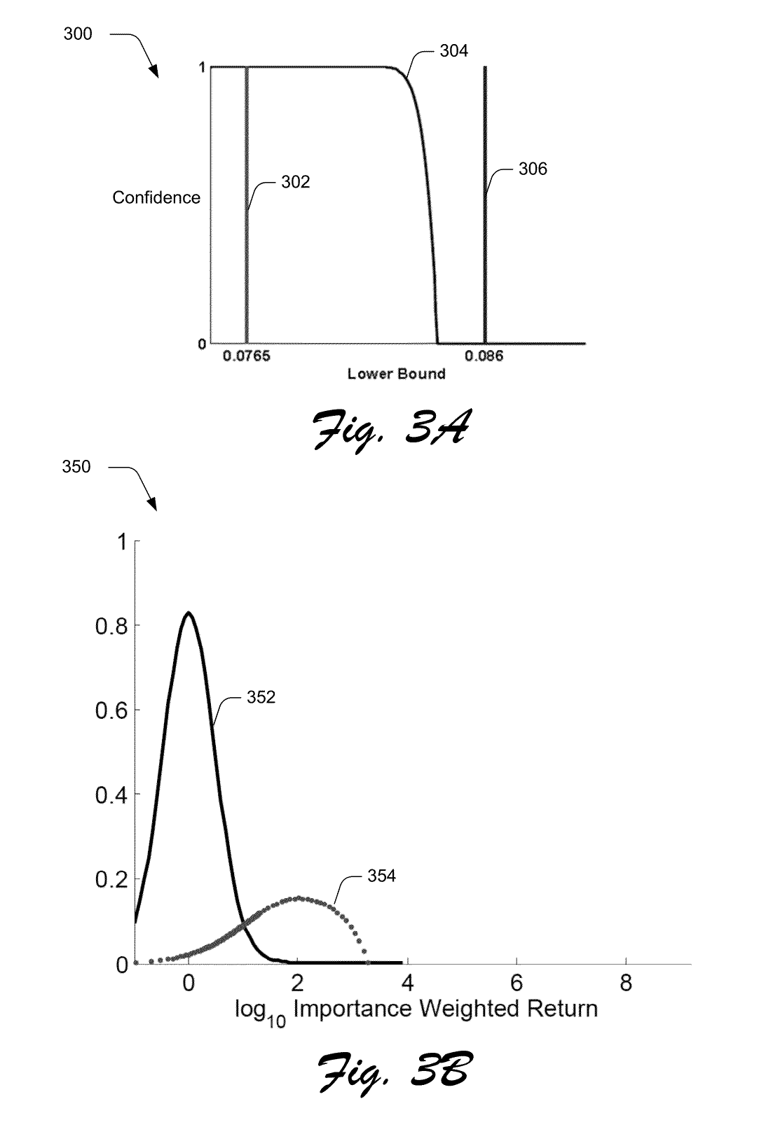

Consider a graph 300 as shown in FIG. 3A. The horizontal axis is “ƒₘᵢₙ”, which is the performance of the policy. The vertical axis is the confidence, and the deploy policy 208 has a performance 302 in the graph 300. The new policy 212 is evaluated using the deployment data 210 collected from the deployment of the deployed policy 208, which results in confidence values 304 as plotted in the graph 300. The confidence values 304 express the confidence that performance is at least the value specified on the horizontal axis and thus are a statistical guarantee of that performance. In the illustrated example, the confidence that performance is at least 0.08 is almost 1. The confidence that performance is at least 0.086 is near zero. It should be noted that this does not mean that actual performance of the new policy 212 is not this good, but rather means that the performance cannot be guaranteed with any real confidence yet.

The confidence values 304 of the statistical guarantee in this example support a strong argument to deploy the new policy 212, since the values express a high confidence that the new policy 212 will perform better than the deployed policy 208. Performance 306 of the new policy 212 indicative of actual deployment in this example is also included in the graph 300. Further discussion of this example may be found in relation to the discussion of Algorithm 1 in the following and is shown in corresponding figures.

In the second example 204, deployment data 210 describing deployment of a deployed policy 208 is also shown. In this example, a policy improvement module 218 is employed to process a plurality of policies 220 to make a policy selection 222 that has an associated statistical guarantee of having performance that is greater that the deployed policy 208. As previously described, conventional approaches did not include a technique to generate a statistical guarantee that one policy would exhibit an improvement over another. As such, it is difficult using these conventional approaches to justify deployment of a new policy, especially since deployment of a bad policy may be costly, e.g., have low click rates.

Functionality that is implemented by the policy improvement module 218 to make this selection is referred to as a “PolicyImprovement Algorithm” and also as “Algorithm 2” in the following. The policy improvement module 218 in this example searches a set of policies 220 and makes a policy selection 222 if that selection is determined to be “safe.” The selection is safe if performance of the policy 220 is better than a level of performance (e.g., “ƒₘᵢₙ”) and within a level of confidence, e.g., “1-δ.”

Both the level of performance (e.g., “ƒₘᵢₙ”) and the level of confidence (e.g., “1-δ”) are definable by a user. For example, a selection by a user of “δ=0.5” and “ƒₘᵢₙ=1.1 multiplied by (performance of a deployed policy)” means that a 10% improvement in performance is guaranteed with a confidence of 95%. Accordingly, the policy improvement module 218 will only suggest a new policy in this example if it can guarantee that it is safe according to this definition of safe. The policy improvement module 218 may make this determination in a variety of ways, such as to employ the confidence evaluation module 214 as described in the first example 202, e.g., Algorithm 1 in the following.

In the third example 206, an automated system for safe policy deployment is shown. In the previous example, a contribution is described in which data is used to select a policy, e.g., as a “batch” in that it takes the existing data and proposes a single new policy. In this example, however, an iterative version of the contribution above is described, functionality of which is illustrated as a policy generation module 224 that is usable to generate a new policy 226. The iterations, for instance, are usable to adjust parameters of a policy, determine with a defined level of confidence whether the policy having adjustments will exhibit better performance than a deployed policy 208, and if so, the new policy 226 is deployed as a replacement. Thus, the policy generation module 224 is configured to make a series of changes to generate the new policy 226, such as to apply functionality represented by the policy improvement module 218 numerous times in succession, with bookkeeping added to track changes made to parameters of the policy.

In the second example 204, deployment data 210 is collected for a period of time (e.g., a month) for a deployed policy 208 to make a policy selection 222 of a new policy 220. In the third example 206, deployment data 210 is collected until a new policy 226 is found, and then the policy manager module 122 causes an immediate switch to execution of the new policy 226, e.g., to replace the deployed policy 208. This process may be repeated for multiple “new” policies to replace deployed policies. In this way, improved performance may be achieved by readily implementing the new policies 226, further discussion of which may be found in relation to description of “Algorithm 3” and “Daedalus” in the following implementation example.

Implementation Example

Let “S” and “A” denote the sets of possible states and actions, where the states describe access to content (e.g., characteristics of a user or the user's access) and actions result from decisions made using a policy 120. Although Markov Decision Process (MDP) notation is used in the following, by replacing states with observations, the results may carry over directly to POMDPs with reactive policies. An assumption is made that the rewards are bounded: “rₜε[rₘᵢₙ,rₘₐₓ],” and “tε [symbol] ” is used to index time, starting at “t=1,” where there is some fixed distribution over states. The expression “π(s,a,θ)” is used to denote the probability (density or mass) of action “a” in state “s” when using policy parameters “θε [symbol] ⁿ^{_{θ}},” where “n_{θ}” is a positive integer, the dimension of the policy parameter space.

Let “ƒ: [symbol] ⁿ^{_{θ}}→ [symbol] ” be a function that takes policy parameters of a policy 120 to the expected return of “π(., ., θ).” That is, for any “θ,”

$$f ( θ ) := E [ {\sum }_{t = 0}^{∞} {γ}^{t - 1} {r}_{t} \vert θ ] ,$$

where “γ” is a parameter in the [0,1] interval that specifies the discounting of rewards over time. The problem may involve a finite horizon, in which, each trajectory reaches a terminal state within “T” time steps. So, each trajectory, “τ,” is an ordered set of states (or observations), actions, and rewards: “τ={s₁, a₁, r₁, s₂, a₂, r₂, . . . , s_{T}, a_{T}, r_{T}}.” To simplify the analysis, without loss of generality, a requirement may be made that returns, “Σₜ₋₁^{T}γ^{t-1}rₜ,” are always in the interval [0,1]. This can be achieved by scaling and translating the rewards.

A data set “D,” is obtained which includes “n” trajectories, labeled with the policy parameters that produced them as follows:

D={(τᵢ,θᵢ):iε{1, . . . ,n},τᵢ generated using θᵢ},

where “θᵢ” denotes the ith parameter vector, “θ,” not the “ith” element of “θ.” Lastly, “ƒₘᵢₙε [symbol] ” and a confidence level, “δε[0,1)” are obtained.

An algorithm is considered safe if it only proposes new policy parameters, “θ,” when it can ensure that “ƒ(θ)>ƒₘᵢₙ” with confidence “1-δ.” Policy parameters, “θ,” (as opposed to an algorithm) are considered safe if it can be ensured that “ƒ(θ)>ƒₘᵢₙ” with confidence “1-δ.” It may be noted that stating that a policy is safe is a statement about beliefs concerning that policy given some data, not a statement about the policy itself. Also note that ensuring that “θ” is safe is equivalent to ensuring that the hypothesis that “ƒ(θ)≦ƒₘᵢₙ” is rejected with significance level “δ”. This confidence and hypothesis-testing framework is adopted because it is not meaningful to discuss “Pr(ƒ(θ)>ƒₘᵢₙ)” or “Pr(ƒ(θ)>ƒₘᵢₙ|D),” since neither “ƒ(θ)” nor “ƒₘᵢₙ” is random.

Let “Θ_{safe}^{D}” denote the set of safe policy parameters given data “D.” First, a determination is made as to what analysis is to be used to generate the largest “Θ_{safe}^{D}” possible given the available data, “D,” i.e., the deployment data 210. If “Θ_{safe}^{D}=Ø,” then the algorithm returns “No Solution Found.” If “Θ_{safe}^{D}#Ø.” The following is an algorithm configured to returns new policy parameters, “θ′εΘ_{safe}^{D},” that are estimated to be “best”:

$${θ}^{′} ∈ arg {max}_{θ ∈ {Θ}_{safe}^{D}} g ( θ , D ) \qquad ( 1 )$$

where “g(θ,D)ε [symbol] ” specifies how “good” is “θ” (i.e., the new policy parameters) based on the provided data, “D.” Typically “g” would be an estimate of “ƒ(θ),” but an allowance is made for any “g.” Another example of “g” is a function similar to “ƒ,” but which takes into consideration the variance of returns. Notice that even though Equation (1) uses “g,” the safety guarantee is uncompromising in that it uses the true (unknown, and often unknowable) expected return, “ƒ(θ).”

Initially, a batch technique is described that takes some data, “D,” and produces a single new set of policy parameters, “θ′,” and is thus a selection of a new policy from a plurality of policies. This batch approach can be extended to an iterative approach that makes multiple policy improvements that are then automatically and immediately deployed as further described below.

Generating Unbiased Estimates of ƒ(θ)

The following technique leverages an ability to generate unbiased estimates, “ƒ(θ,τ,θᵢ) of ƒ(θ),” from each trajectory, “τεD” that is generated using behavior policy “θᵢ.” Importance sampling is used to generate these unbiased estimates as follows:

$$\hat{f} ( θ , τ , {θ}_{i} ) := \underbrace{{\prod }_{t = 1}^{T} \frac{π ( {s}_{t} , {α}_{t} , θ )}{π ( {s}_{t} , {α}_{t} , {θ}_{i} )}}_{importance weight} \underbrace{{\sum }_{t = 1}^{T} {γ}^{t - 1} {r}_{t}}_{return} \qquad ( 2 )$$

Notice that division by zero does not occur in (2), since “aₜ” is not chosen in the trajectory if “π(sₜ,aₜ,θᵢ)=0.” However, in order for importance sampling to be applicable, a requirement is made that “π(s,a,θ)” to be zero for all “s” and “a” where “π(s,a,θᵢ)=0.” If this is not the case, then data from “θᵢ” may not be used to evaluate “θ.” Intuitively, if a behavior policy will never execute action “a” in state “s,” then there is no information regarding the outcome when the evaluation policy executes “a” in “s.”

For each θᵢ, \hat{ƒ}(θ,τ,θᵢ) is a random variable that is computed by sampling “τ” using “θᵢ” and then using Equation (2). Since importance sampling is unbiased,

E[\hat{ƒ}(θ,τ,θᵢ)]=ƒ(θ)

for all “i.” Because the smallest possible return is zero and the importance weights are nonnegative, the importance weighted returns are bounded below by zero. However, when “θ” results in actions being likely in states where the actions are unlikely under “θᵢ,” the importance weighted returns may be large. So, “\hat{ƒ}(θ,τ,θᵢ)” is a random variable that is bounded below by zero, has expected value in the [0; 1] interval, and has a large upper bound. This means that \hat{ƒ}(θ,τ,θᵢ) may have a relatively long tail, as shown in an example graph 350 of FIG. 3B.

Curve 352 is an empirical estimate of the probability density function (PDF) of “\hat{ƒ}(θ,τ,θᵢ)” on a mountain-car domain with simplifications and “T=20.” The vertical axis corresponds to a probability density. Curve 304 is described later in the following discussion. The behavior policy parameters, “θᵢ” produce a suboptimal policy and the evaluation policy parameters “θ” are selected along the natural policy gradient from “θᵢ.” The probability density function (PDF) is estimated in this example by generating 100,000 trajectories, computing corresponding importance weighted returns, and then passing those to a ksdensity function. The tightest upper bound on the importance weighted return is approximately 10^{9.4}, although the largest observed importance weighted return is approximately 316. The sample mean is approximately 0.2≈10^{-0.7}. Notice that the horizontal axis is scaled logarithmically, e.g., base ten.

Concentration Inequality

In order to ensure safety, a concentration inequality 126 is employed as described above. The concentration inequality 126 is utilized as a bound to the confidence values and thus is used to provide a statistical guarantee of performance, e.g., that estimated values of a measure of performance of the policy at least correspond to a defined value. The concentration inequality 126 may take a variety of different forms, such as a Chernoff-Hoeffding inequality. This inequality is used to compute a confidence that the sample mean (average \hat{ƒ}(θ,τ,θᵢ)) over each of the trajectories from each of the policies is bounded, e.g., does not deviate much from the true mean, “ƒ(θ).”

Each of the concentration inequalities are presented in the following as applied to “n” independent and identically distributed random variables, “X₁, . . . , Xₙ,” where “Xᵢε[0,b]” and “E[Xᵢ]=μ” for all “i.” In the context of these techniques, these “Xᵢ” correspond to “\hat{ƒ}(θ,τ,θᵢ)” from “n” different trajectories using the same behavior policy and “μ=ƒ(θ).” A first example of a concentration inequality is the Chernoff-Hoeffding (CH) inequality:

$$Pr ( μ \geq \frac{1}{n} {\sum }_{i = 1}^{n} {X}_{i} - \frac{b}{\sqrt{n}} \sqrt{\frac{ln ( 1 / δ )}{2}} ) \geq 1 - δ \qquad ( 3 )$$

In a second example, Maurer and Pontil's empirical Bernstein (MPeB) inequality is presented, which replaces the true (unknown in this setting) variance in Bernstein's inequality with the sample variance as follows:

$$Pr ( μ \geq \frac{1}{n} {\sum }_{i = 1}^{n} {X}_{i} - \frac{b}{n - 1} ( \frac{7 ln ( 2 / δ )}{3} ) - \frac{1}{n} \sqrt{\frac{ln ( 2 / δ )}{n - 1} {\sum }_{i , j = 1}^{n} {( {X}_{i} - {X}_{j} )}^{2}} ) \geq 1 - δ \qquad ( 4 )$$

In a third example, Anderson's (AM) inequality is shown below as using the Dvoretzky-Kiefer-Wolfowitz inequality with the optimal constants found by Massart as follows:

$$Pr ( μ \geq {z}_{n} - {\sum }_{i = 0}^{n - 1} ( {z}_{i + 1} - {z}_{i} ) min \{ 1 , \frac{i}{n} + \sqrt{ln ( \frac{2}{1 - δ} ) \frac{1}{2} n} \} ) \geq 1 - δ , \qquad ( 5 )$$

where “z₁, z₂, . . . , zₙ” are the order statistics of samples of “X₁, X₂, . . . , Xₙ” and “z₀=0.” That is, the “zᵢ” are the samples of the random variables “X₁, X₂, . . . , Xₙ,” sorted such that “z₁≦z₂≦ . . . zₙ,” and “z₀=0.”

Notice that Equation (3) solely considers the sample mean of the random variables, while Equation (4) considers both the sample mean and sample variance. This allows Equation (4) to decrease the effect of the range, “b,” i.e., in Equation (4) the range is divided by “n−1,” whereas in Equation (3) it is divided by “\sqrt{n}.” Equation (4) considers solely the sample mean and sample variance, Equation (5) considers the entire sample cumulative distribution function. This allows Equation (5) to depend solely on the largest observed sample, and not “b.” This can be a significant improvement in some situations, such as an example situation shown in FIG. 3, where the largest observed sample is approximately 316 while “b” is approximately 10^{9.4}.

In another example, the MPeB inequality shown above is extended to be independent of the range of the random variables. This results in a new inequality that combines desirable properties of the MPeB inequality (e.g., general tightness and applicability to random variables that are not identically distributed) with desirable properties of the AM inequality, e.g., no direct dependence on the range of the random variables. It also removes a need to determine a tight upper bound on the largest possible importance weighted return, which could involve expert consideration of domain-specific properties.

This extension of the MPeB inequality leverages two insights. The first insight is that removing the upper tail of a distribution lowers its expected value. The second insight is that the MPeB inequality may be generalized to handle random variables with different ranges if it is simultaneously specialized to random variables with the same mean. So, the tails of the random variables' distributions are collapsed and the random variables normalized in this example such that the MPeB inequality can be applied. The MPeB inequality is then used to generate a lower-bound from which a lower-bound on the uniform mean of the original random variables i extracted. The resulting concentration inequality is provided in Theorem 1 below.

The approach for collapsing the tails of distributions and then bounding the mean of the new distribution is similar to bounding the truncated or winsorized mean estimators. However, whereas the truncated mean discards each of the samples above some threshold, samples in the present techniques are moved from above the threshold to lie exactly on the threshold. This is similar to computing the winsorized mean, except that the threshold is not data dependent.

In Theorem 1, let “X=(X₁, . . . , Xₙ)” be a vector of independent random variables where “Xᵢ≧0” and all “Xᵢ” have the same expected value, “μ.” Let “δ>0” and select any “cᵢ>0” for all “i.” Then, with probability at least “1-δ”:

$$μ > \underbrace{{( {\sum }_{i = 1}^{n} \frac{1}{{c}_{i}} )}^{- 1}}_{sealing term} ( \underbrace{{\sum }_{i = 1}^{n} \frac{{Y}_{i}}{{c}_{i}}}_{sample mean} - \underbrace{\sqrt{\frac{ln ( 2 / δ )}{( n - 1 )} {\sum }_{i , j = 1}^{n} {( \frac{{Y}_{i}}{{c}_{i}} - \frac{{Y}_{j}}{{c}_{j}} )}^{2}} - \frac{7 n ln ( 2 / δ )}{3 ( n - 1 )}}_{terms that , after being scaled , go to zero as n \to ∞} ) \qquad ( 6 )$$

where “Yᵢ:=min{Xᵢ,cᵢ}.”

In order to apply Theorem 1, values are selected for each “cᵢ,” the threshold beyond which the distribution of “Xᵢ” is collapsed. To simplify this task, a single “cε [symbol] ” is selected and “cᵢ=c” is set for all “i.” When “c” is too large, it loosens the bound just like a large range “b,” would. When “c” is too small, it decreases the true expected values of the “Yᵢ,” which also loosens the bound. Thus, the optimal “c” balances this tradeoff between the range of “Yᵢ” and the true mean of “Yᵢ.” The provided random variables are partitioned into two sets, “Dₚᵣₑ” and “Dₚₒₛₜ.” “Dₚᵣₑ” is used to estimate the optimal scalar threshold, “c,” as (the maximized function in this equation is the right side of Equation (6) with scalar “c”):

$$c ∈ arg {max}_{c} \frac{1}{n} {\sum }_{i = 1}^{n} {Y}_{i} - \sqrt{\frac{2 ln ( 2 / δ )}{{n}^{2} ( n - 1 )} ( n {\sum }_{i = 1}^{n} {Y}_{i}^{2} - {( {\sum }_{i = 1}^{n} {Y}_{i} )}^{2} )} - \frac{7 c ln ( 2 / δ )}{3 ( n - 1 )} \qquad ( 7 )$$

Recall that “Yᵢ:=min{Xᵢ,cᵢ},” so each of the three terms in Equation (7) depend on “c.” Once an estimate of the optimal “c” had been formed from “Dₚᵣₑ” Theorem 1 is applied using the samples in “Dₚₒₛₜ” and the optimized “c” value. In one or more implementations, it has been found that using ⅓ of the samples in “Dₚᵣₑ” and the remaining ⅔ in “Dₚₒₛₜ” performs well in an application where it is known that the true mean is in [1,0], “c≧1”. When some of the random variables are identically distributed, it may be ensured that the variables are divided with ⅓ in “Dₚᵣₑ” and ⅔ in “Dₚₒₛₜ.” In one or more implementations, this ad hoc scheme for determining how many points to include in Dₚᵣₑ is improved to select different “cᵢ” for each random variable.

The curve 354 in FIG. 3B illustrates the tradeoff when selecting “c.” It gives the 95% confidence lower bound on the mean, “ƒ(θ),” (vertical axis) for the value of “c” specified by the horizontal axis. The optimal “c” value in one or more implementations is around 10². Curve 304 continues below the horizontal axis. In this case, when “c=10^{9.4},” the inequality degenerates to the MPeB inequality, which produces a 95% confidence lower bound on the mean of −129, 703.

Using the 100,000 samples used to create FIG. 3B, the 95% confidence lower bound on the mean is computed using Theorem 1 with the ⅓, ⅔ data split, and also the CH, MPeB, and AM inequalities. The collapsed-AM inequality is also derived and tested, which is an extension of the AM inequality to use the scheme described herein of collapsing “Xᵢ” into “Yᵢ” with a “c” value optimized from ⅓ of the data. The results are provided in Table 400 shown in FIG. 4. This comparison shows the power of the concentration inequality for long-tailed distributions like those generated by importance sampling. It also shows that the AM inequality does not appear to benefit from the collapsing scheme that is applied to the MPeB inequality.

Ensuring Safety in Policy Search

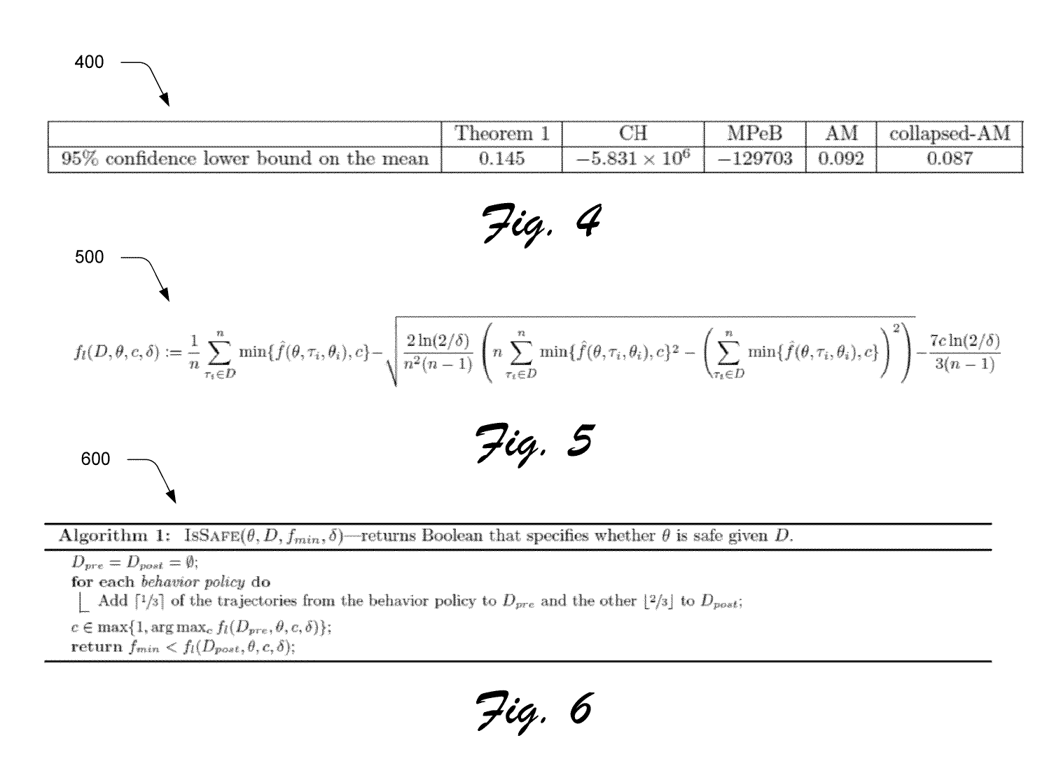

In order to determine whether policy parameters “θ” are safe given the provided data “D,” the concentration inequality from Section 4 is applied to the importance weighted returns. For brevity, let “ƒₗ(D,θ,c,δ)” be the “1-δ” confidence lower bound on “ƒ(θ)” produced by Theorem 1 when using the trajectories in “D” and the provided threshold, “c,” to evaluate “θ” as shown in the example 500 of FIG. 5, where “n” is the number of trajectories in “D.” Pseudo code to determine whether “θ” is safe given “D” is provided in Algorithm 1 shown in the example 600 of FIG. 6.

Oracle-Constrained Policy Search

The above describes a technique to determine whether policy parameters are safe, a suitable objective function “g” is then selected and safe parameters that maximize “g” are found using the function. Any off-policy evaluation technique may be used for “g,” such as a risk-sensitive “g,” which favors “θ” with larger expected return but also smaller variance of returns. For simplicity, in weighted importance sampling is used for “g” in the following:

$$g ( θ , D ) := {\sum }_{i = 1}^{n} \frac{\hat{f} ( θ , {τ}_{i} , {θ}_{i} )}{{\prod }_{t = 1}^{T} \frac{π ( {s}_{t} , {a}_{t} , θ )}{π ( {s}_{t} , {a}_{t} , {θ}_{i} )}} .$$

Selecting “θ′” according to Equation (1) is a form of a constrained optimization problem since a simple analytical expression for “Θ_{safe}^{D}” is not available. Rather, a membership oracle is available, with which, a determination is made as to whether a “θ” is in “Θ_{safe}^{D},” using Algorithm 1. When “n_{θ}” is small, this constrained optimization problem is brute forced using a grid search or randomized search over each possible “θ.” However, as “n_{θ}” grows, this technique becomes intractable.

To overcome this, a natural policy gradient algorithm is used to reduce the search to several constrained line searches. Intuitively, rather than search each of “ [symbol] ⁿ^{_{θ}},” a single direction, \tilde{∇}ƒ(θ) is selected from each behavior policy “θ” that is expected to intersect a safe region of policy space, and a search in these directions is performed. The direction that is chosen from each behavior policy is a generalized natural policy gradient. Although there are no guarantees that the generalized natural policy gradient points towards a safe region, it is a reasonable choice of direction because it points in the direction that causes the expected return to increase most rapidly. Although any algorithm for computing the generalized natural policy gradient may be used, the biased natural actor-critic with LSTD is used in this example. The constrained line search problem is solved by brute force.

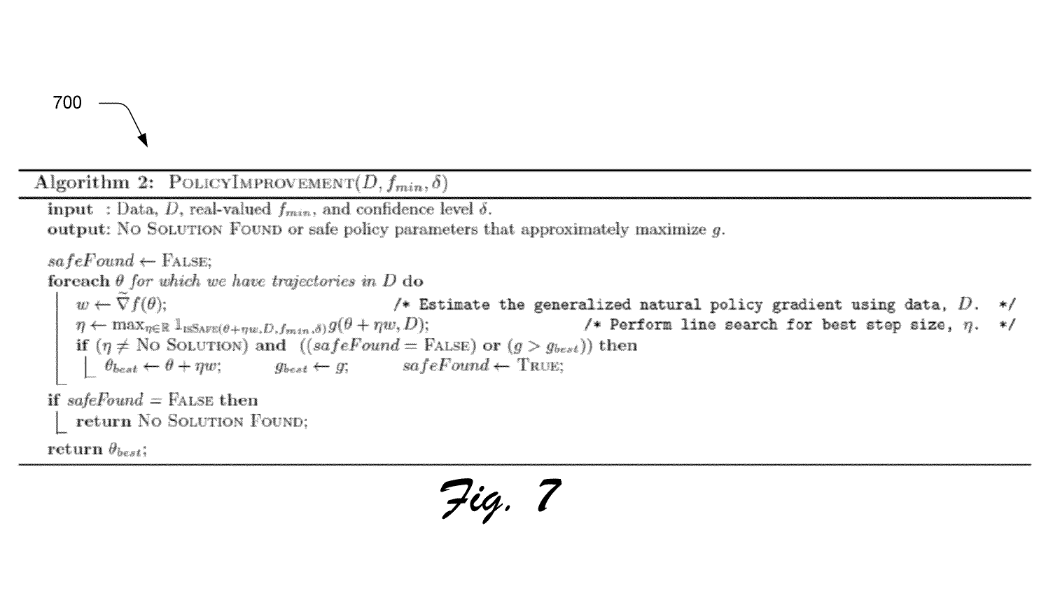

The pseudo code for this algorithm is provided in Algorithm 2, an example 700 of which is illustrated in FIG. 7, where the indicator function, “1_{A}”, is one if “A” is true and 0 otherwise.

Multiple Policy Improvements

Policy improvement techniques use a batch method in the above discussion that is applied to an existing data set, “D.” However, the techniques may also be used in an incremental manner by executing new safe policy parameters whenever found. The user may choose to change “ƒₘᵢₙ” at each iteration, e.g., to reflect an estimate of the performance of the best policy found so far or the most recently proposed policy. However, in pseudo code described herein, an assumption is made that the user does not change “ƒₘᵢₙ.”

Let “θ₀” denote a user's initial policy parameters. If “ƒₘᵢₙ=ƒ(θ₀),” then it may be said with high confidence that each policy that is proposed will be at least as good as if the user continued to use an initial policy. If “ƒₘᵢₙ” is an estimate of “ƒ(θ₀),” then it can be said with high confidence that each policy that is proposed will be at least as good as the observed performance of the user's policy. The user may also select “ƒₘᵢₙ” to be lower than “ƒ(θ₀),” which gives the algorithm more freedom to explore while ensuring that performance does not degrade below a specified level.

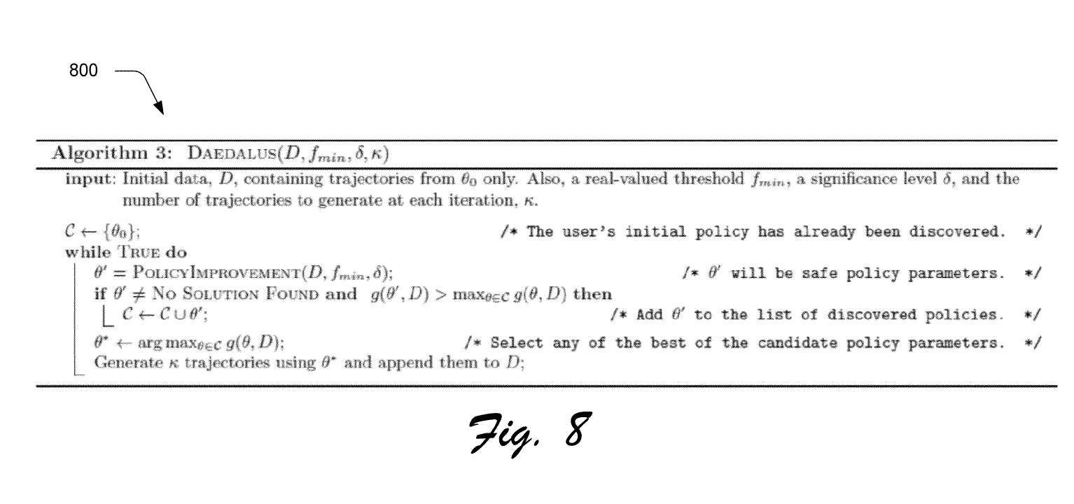

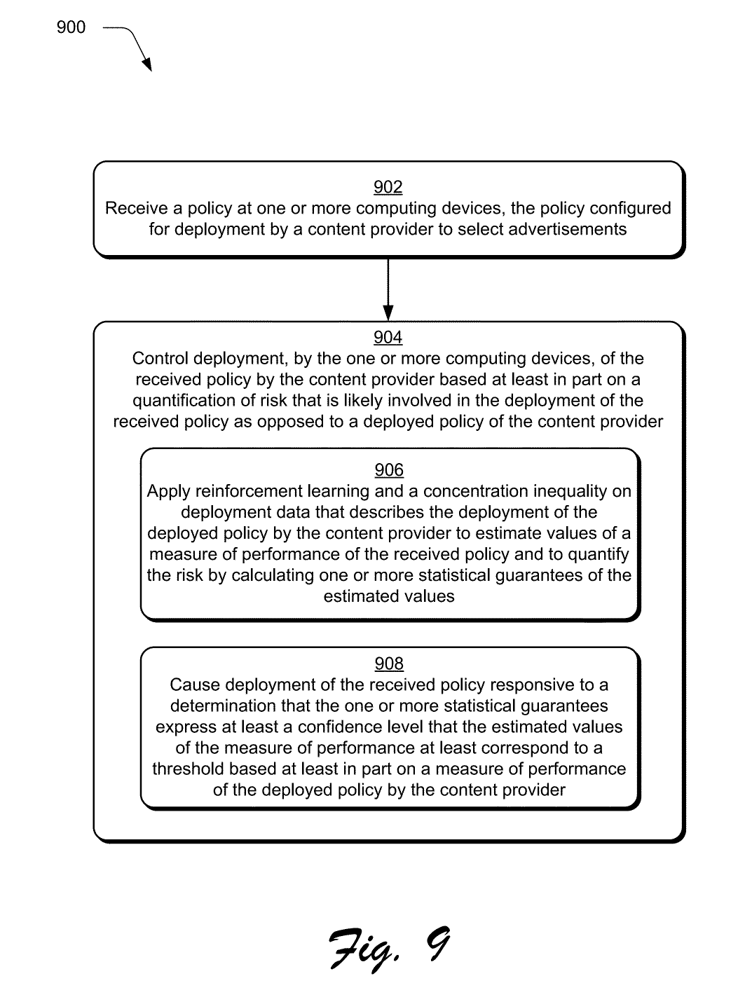

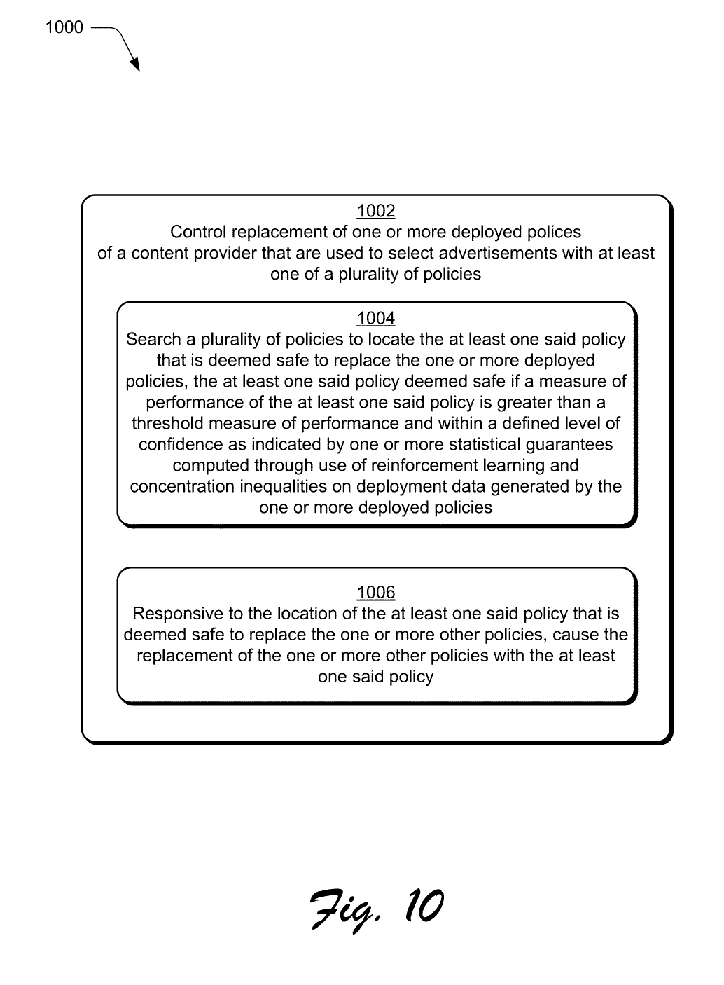

The algorithm maintains a list “C” of the policy parameters that it has deemed safe. When generating new trajectories, the algorithm uses the policy parameters in “C” that are expected to perform best to generate a new policy 226 as described in relation to FIG. 2. Pseudo code for this online safe learning algorithm is presented in Algorithm 3, an example 800 of which is illustrated in FIG. 8, which is referred to also as Daedalus in the figure. Further discussion of these and other examples is described in relation to the following procedures.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-8.

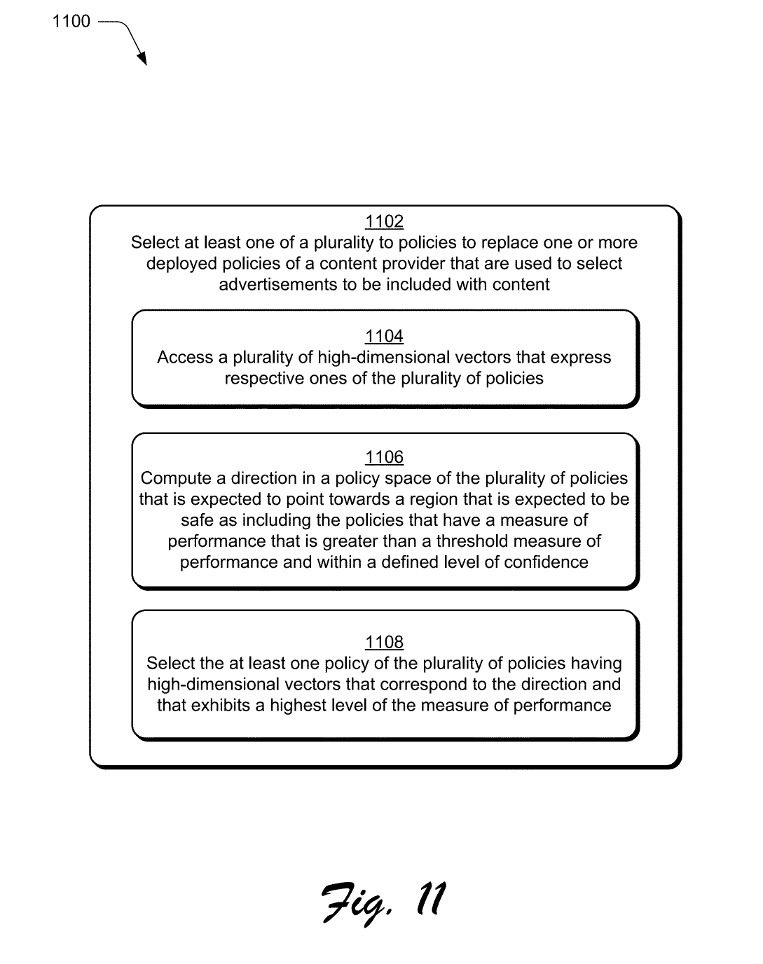

FIG. 9 depicts a procedure 900 in an example implementation in which techniques involving risk quantification for policy improvement are described. A policy is received that is configured for deployment by a content provider to select advertisements (block 902). A technician, in one instance, creates the policy through manual interaction with the content manager module 116, such as via a user interface to specific parameters of the policy. In another instance, the policy is created automatically and without user intervention, such as by the content manager module 116 through automatic adjustment of parameters to create new policies that have a potential of exhibiting an improvement in a measure of performance, such as a number of interactions (e.g., “clicks”), conversion rate, and so forth.

Deployment of the received policy by the content provider is controlled based at least in part on a quantification of risk that is likely involved in the deployment of the received policy as opposed to a deployed policy of the content provider (block 904). As previously described, use of policies by content providers 102 is not static in that the policies are frequency changed with new policies that better leverage known information about the users that are to receive advertisements selected through use of the policies. In this example, deployment is controlled through use of a statistical guarantee that a new policy will increase a measure of performance (e.g., Lifetime Value of interaction or conversion) and as such reduce risk that the new policy will cause a decrease in performance and corresponding revenue.

The control is based on applying reinforcement learning and a concentration inequality on deployment data that describes the deployment of the deployed policy by the content provider to estimate values of a measure of performance of the received policy and to quantify the risk by calculating one or more statistical guarantees of the estimated values (block 906). The control also includes causing deployment of the received policy responsive to a determination that the one or more statistical guarantees express at least a confidence level that the estimated values of the measure of performance at least correspond to a threshold based at least in part on a measure of performance of the deployed policy by the content provider (block 908). In other words, the policy is deployed in the above when the policy is determined to be safe to do so based on the statistical guarantee.

The content manager module 116, for instance, obtains deployment data for the deployed policies and then uses this data as a basis for assessing the risk of deployment of the received policy, and thus may do so without actually deploying the new policy. In another example, if the received policy has been deployed, the policy manager module leverages both the data from previous policies and the data accumulated from deploying the new policy.

Unlike existing techniques, which merely estimate the performance of a policy without any guarantee about the accuracy of the estimate, the policy manager module 122 through use of reinforcement learning and concentration inequalities provides both an estimate of performance and a statistical guarantee that the estimate is not an overestimate. That is, the policy manger module 122 provides the probability through the statistical guarantee that the policy will perform at least as well as estimated and thus acts to quantify risk in deployment of the policy.

As describe above in relation to Theorem 1 and Algorithm 1, Theorem 1 as applied by the policy manager module 1122 uses data describing deployment of any number of previous or currently deployed policies and a threshold performance level, ƒₘᵢₙ, and produces the probability that the true performance of the received policy is at least ƒₘᵢₙ, i.e., the threshold level of the measure of performance.

For Algorithm 1, a user may specify both a confidence level (e.g., 1-δ as described above) and the threshold of the measure of performance ƒₘᵢₙ. A policy is deemed safe if a guarantee can be made that its true performance is at least ƒₘᵢₙ with at least a set confidence level, e.g., 1-δ. Algorithm 1 may thus use Theorem 1 to determine whether the policy is safe as part of processing by the policy manager module 122 through use of reinforcement learning and concentration inequalities that takes an input the received policy (e.g., written as θ above), deployment data D, and both the threshold of the measure of performance ƒₘᵢₙ and confidence level (e.g., 1-δ) and returns either true or false to denote whether the policy is safe.

Thus, in this example the received policy is first processed by the policy manager module 122 using the reinforcement learning module 124 and concentration inequalities 126 in order to quantify risk associated with its deployment. The quantification of risk and its use in control of deployment of the policy provides a significant benefit in that dangerous or risky policies may be flagged before deployment. Not only does this help avoid deployment of bad (i.e., underperforming) policies, it provides the freedom to generate new policies and selection techniques without fear of deployment of bad policies, further discussion of which is described in the following and shown in corresponding figures.

FIG. 10 depicts a procedure 1000 in an example implementation in which control of replacement of one or more deployed policies involving a policy search is described. Replacement is controlled of one or more deployed polices of a content provider that are used to select advertisements with at least one of a plurality of policies (block 1002). As described above, reinforcement learning and concentration inequalities are usable to determine whether it is safe to deploy a new policy. In this example, these techniques are applied to make a selection from policies to determine which policy, if any, is to be deployed.

The control includes searching a plurality of policies to locate the at least one policy that is deemed safe to replace the one or more deployed policies, the at least one policy deemed safe if a measure of performance of the at least one policy is greater than a threshold measure of performance and within a defined level of confidence as indicated by one or more statistical guarantees computed through use of reinforcement learning and concentration inequalities on deployment data generated by the one or more deployed policies (block 1004). For example, the policy manager module 122 uses data describing deployment of any number of previous or currently deployed policies and a threshold performance level, ƒₘᵢₙ, and produces the probability that the true performance of the received policy is at least ƒₘᵢₙ, i.e., the threshold level of the measure of performance. In this example, this technique is applied to a plurality of polices to determine which of the policies meets this requirement, and if so, which of the policies is likely to exhibit the best performance, e.g., lifetime value as defined by a number of interactions or conversions.

Responsive to the location of the at least one said policy that is deemed safe to replace the one or more other policies, the replacement is caused of the one or more other policies with the at least one said policy (block 1006). The policy service 104, for instance, may communicate an indication to the content provider 102 to switch from a deployed policy to the selected policy. In another example, this functionality is implemented as part of the content provider 102, itself. Techniques may also be employed to improve efficiency in the calculation of this selection, an example of which is described in the following and shown in a corresponding figure. FIG. 11 depicts a procedure 1100 in an example implementation in which selection of policies to replace deployed policies is performed by leveraging a policy space to improve efficiency. At least one of a plurality to policies is selected to replace one or more deployed policies of a content provider that are used to select advertisements to be included with content (block 1102). The selection is performed in this example by leveraging a policy space that describes the policies.

The selection, for example, includes accessing a plurality of high-dimensional vectors that express respective ones of the plurality of policies (block 1104). The plurality of high-dimensional vectors, for instance, describe parameters used by the policies in making a selection of an advertisement based on characteristics of a request to access content that includes the advertisement.

A direction is computed in a policy space of the plurality of policies that is expected to point towards a region that is expected to be safe as including the policies that have a measure of performance that is greater than a threshold measure of performance and within a defined level of confidence (block 1106). The at least one policy of the plurality of policies is selected that has high-dimensional vectors that correspond to the direction and that exhibits a highest level of the measure of performance (block 1108). The direction is computed that is expected to point towards the safe region is a generalized natural policy gradient (GeNGA), which is an estimate of a direction in the policy space that causes performance to increase in the quickest manner relative to other regions in the policy space. A search is the performed that is constrained by the direction such that a line search is performed for high-dimensional vectors that correspond to this direction. These line searches are low dimensional and can be brute forced and thus improves efficiency in the location of these policies.

From the policies that correspond to the direction, a policy is located from these policies based on a measure of performance and a confidence level as described in relation to FIG. 9. The policy manager module 122 uses reinforcement learning and concentration inequalities to determine which of the policies is the safest to deploy based on the threshold measure of performance and defined level of confidence as indicated by the statistical guarantees. In this way, the policy manager module 122 automates a search for new safe policies to deploy through use of a safe region and thus reduces an amount of data processed and also that the policies in the safe region may exhibit significantly better level of performance that currently deployed policies. These techniques may also be leveraged to generate new policies automatically and without user intervention, an example of which is described as follows and shown in a corresponding figure.

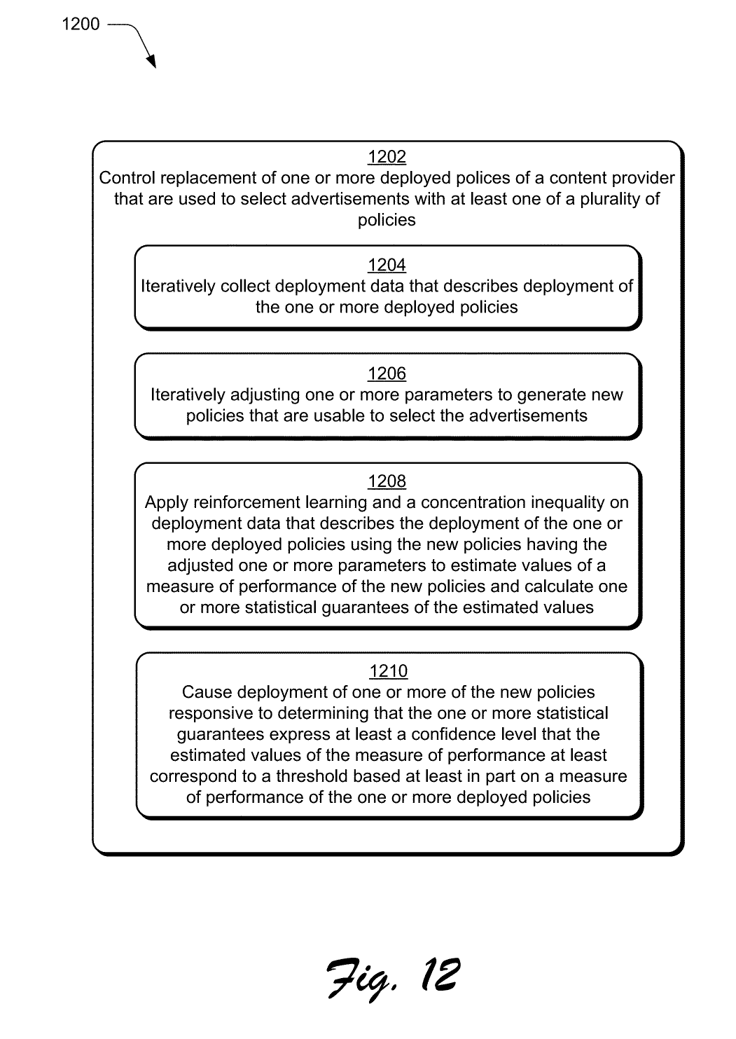

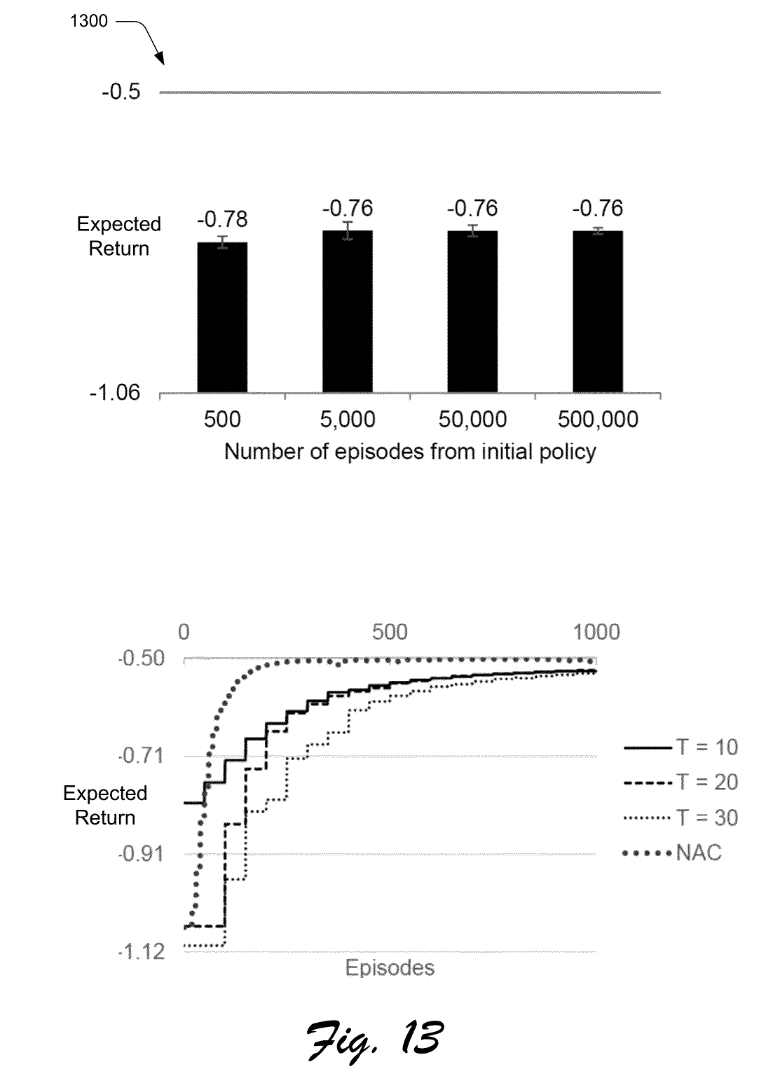

FIG. 12 depicts a procedure 1200 in an example implementation in which new policies are generated iteratively and used to replace deployed policies. Replacement is controlled of one or more deployed polices of a content provider that are used to select advertisements with at least one of a plurality of policies (block 1202). In this example, replacement involves generation of a new policy using iterative techniques that is to be used to replace a deployed policy. Statistical guarantee techniques are included as part of this process to ensure safety of this deployment.

Deployment data is iteratively collected that describes deployment of the one or more deployed policies (block 1204). As before, the deployment data 210 described deployment of a deployed policy 208, which may or may not include data describing deployment of a new policy.

One or more parameters are iteratively adjusted to generate new policies that are usable to select the advertisements (block 1206). The parameters, for instance, are included as part of the policy and express how the policy is to select an advertisement based on characteristics associated with the request. The characteristics are usable to describe an originator of the request (e.g., a user and/or client device 106), characteristics of the request itself (e.g., time of day), and so forth. Accordingly, the policy generation module 224 of the policy manager module 122 in this example adjusts these parameters iteratively and in a variety of combinations to form the new policies. Continuing with the example of FIG. 11, these adjustments are usable to further refine a safe region of a policy space such that the adjusted parameters further bias the new policies toward this safe region, i.e., such that the high-dimensional vectors representative of the policies more closely align with the safe region.

Reinforcement learning and a concentration inequality are applied on deployment data that describes the deployment of the one or more deployed policies using the new policies having the adjusted one or more parameters to estimate values of a measure of performance of the new policies and calculate one or more statistical guarantees of the estimated values (block 1208). This application is used to determine a level of confidence that the new policies will result in an increase in a measure of performance of the new policies over the deployed policies.

Deployment is caused of one or more of the new policies responsive to determining that the one or more statistical guarantees express at least a confidence level that the estimated values of the measure of performance at least correspond to a threshold based at least in part on a measure of performance of the one or more deployed policies (block 1210). For example, the policy generation module 224 is configured to call the policy improvement module 218 iteratively, and causes deployment of the new policies upon identification of a threshold level of improvement within a defined level of confidence.

In one or more implementation, if upon deployment the new policy is found to have a lower performance, the policy manager module 122 ceases deployment of the new policy and deploys a different new policy, reverts back to a previously deployed policy, and so on. Thus, in this example, the policy generation module 224 automates a search for new safe policies to deploy. Also, unlike the example described in relation to FIG. 11, this example is performed incrementally through adjustment of the parameters automatically and without user intervention.

Example Case Studies

Three case studies are presented in the following. The first case study presents results in which a simple gridworld is selected for the first case study. The second case study shows that the third algorithm is robust to partial observability. The third case study uses system identification techniques to approximate a real world digital marketing application.

4×4 Gridworld

This example begins with a 4×4 gridworld with deterministic transitions. Each of the states result in a reward of −0.1, except for the bottom-right most state which results in a reward of zero and is terminal. Episodes are terminated after “T” steps if the terminal state is not already reached and “γ=1.” An optimal policy's expected return is −0.5. A pessimal policy has expected return “−1” when “T=10”, “−2” when “T=20,” and “−3” when “T=30.” A hand-crafted initial policy is selected which performs well but leaves room for improvement, and “ƒₘᵢₙ” is set to be an estimate of this policy's expected return (notice that “ƒₘᵢₙ” varies with “T”). Finally, “κ=50,” and “δ=0.05.⁵”

FIG. 13 shows results 1300 of performing the policy improvement techniques and Algorithm 3 on this problem. All reported expected returns in both case studies are computed by generating 10⁵ trajectories using each policy and computing the Monte-Carlo return. Expected returns of the policies that are generated by batch policy improvement techniques when “T=20” are shown. The initial policy has expected return −1.06 and an optimal policy has an expected return of −0.5. Standard error bars from the three trials are also illustrated on the top example. In the bottom example, expected return of the policies generated by Algorithm 3 and NAC and over 1000 episodes is illustrated with various “T” (the NAC curve is for “T=20). Each of the curves are averaged over ten trials and the largest standard error is 0.067. The plot spans 1000/k−20 calls to the policy improvement technique.

Algorithm 3 is compared to the biased natural actor-critic (NAC) using LSTD, modified to clear eligibility traces after each episode. Although NAC is not safe, it provides a baseline to show that Algorithm 3 can add its safety guarantee without sacrificing significant amounts of learning speed. The results are particularly impressive because the performance shown for NAC uses a manually tuned step size and policy update frequency, while no hyper-parameters were tuned for Algorithm 3. Notice that, due to the choice of concentration inequality, performance does not degrade rapidly as the maximum trajectory length increases.

Notice that Algorithm 3 achieves larger expected return using a few hundred trajectories than the batch application of policy improvement technique achieves with a hundreds of thousands of trajectories. This highlights a notable property of Algorithm 3 in which the trajectories tend to be sampled from increasingly-good regions of policy space. This exploration provides more information about the value of even better policies than if the trajectories were all generated using the initial policy.

Digital Marketing POMDP

The second case study involves a company's optimization of individualized advertising of a product. At each period (time step) the company has three options: promote, sell, and NULL. The promote action denotes promotions of the product without the direct intent of generating an immediate sale (e.g., providing information about the product), which incurs a marketing cost. The sell action denotes promotion of the product with the direct intent of generating an immediate sale (e.g., offering a sale on the product). The NULL action denotes no promotion of the product.

The underlying model of customer behavior is based on a recency and frequency scheme. Recency “r” refers to how many periods it has been since the customer made a purchase, while frequency “ƒ” refers to how many purchases the customer has made. In order to better model customer behavior, a real-valued term is added to the model, customer satisfaction (cs). This term depends on the customer's entire interaction with the company and is not observable, i.e., the company has no way of measuring it. This hidden state variable allows for more interesting dynamics. For example, “cs” might decrease if the company tries to sell the customer the product in the period after the customer purchased the product (a customer who purchased a product might not enjoy seeing advertisements for it at a lower price several months later, but might enjoy non-sales-based promotions).

The resulting POMDP has 36 states and one real-valued hidden variable, 3 actions, “T=36,” and “γ=0.95.” Values of “κ=50,” “δ=0.05” are selected and an initial policy that performs reasonably well, but has room for improvement. Its expected return is approximately 0.2, while an optimal policy's expected return is approximately 1.9 and a pessimal policy's expected return is approximately −0.4. A value of “ƒₘᵢₙ=0.18” is selected, which denotes that no more than ten percent degradation in revenue is acceptable.

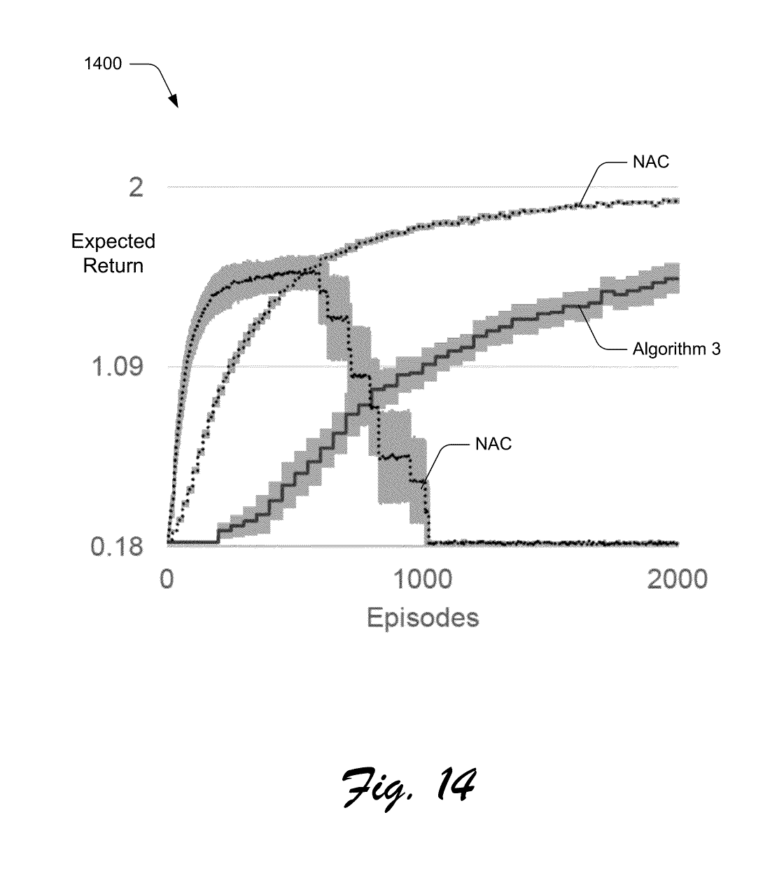

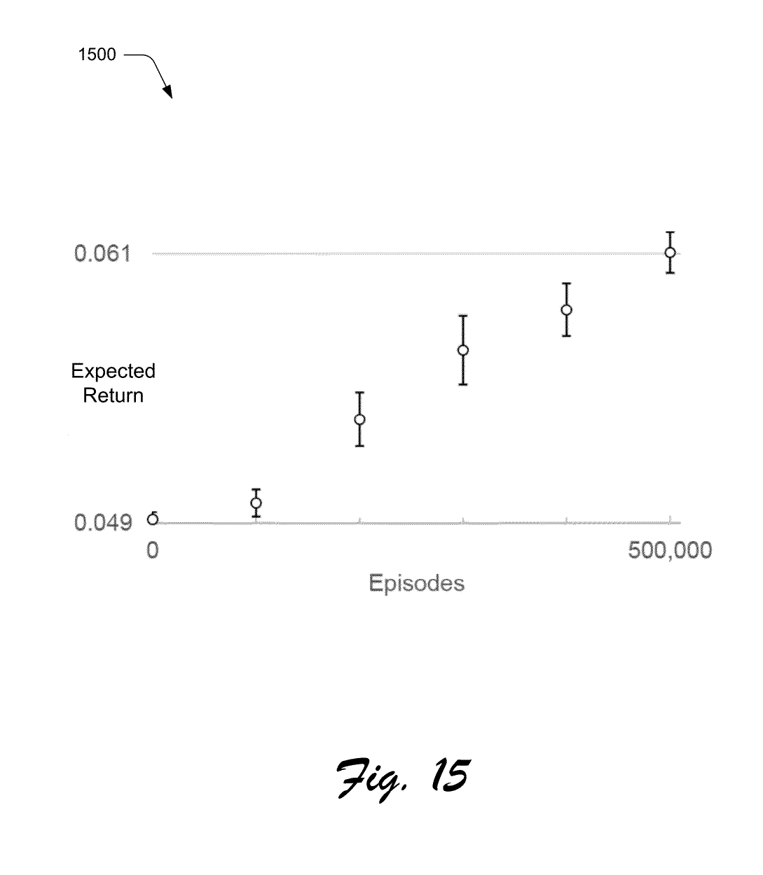

FIG. 14 presents example results 1400, again compared to the performance of NAC with manually optimized hyper-parameters. To emphasize that NAC is not a safe algorithm, the performance of NAC is also shown when the step size is twice the manually optimized value. This example illustrates the benefits of Algorithm 3 over conventional RL algorithms, especially for high-risk applications. Again, no hyper-parameters were tuned for Algorithm 3. Although NAC performs well with optimized hyper-parameters, these parameters are not usually known, and unsafe hyper-parameters may be executed during the search for good hyper-parameters. Furthermore, even with the optimized hyper-parameters, NAC does not provide a safety guarantee (although empirically it appears to be safe).

Digital Marketing Using Real-World Data

Adobe® Marketing Cloud is a powerful set of tools that allows companies to fully leverage digital marketing using both automated and manual solutions. One component of the Adobe® Target tool allows for automated user-specific targeting of advertisements and campaigns. When a user requests a webpage that contains an advertisement, the decision of which advertisement to show is computed based on a vector containing all of the known features of the user.

This problem tends to be treated as a bandit problem, where an agent treats each advertisement as a possible action and it attempts to maximize the probability that the user clicks on the advertisement. Although this approach has been successful, it does not necessarily also maximize the total number of clicks from each user over his or her lifetime. It has been shown that more far-sighted reinforcement learning approaches to this problem can improve significantly upon myopic bandit solutions.

A vector of 31 real-valued features is produced that provide a compressed representation of all of the available information about a user. The advertisements are clustered into two high-level classes from which the agent is to select. After the agent selects an advertisement, the user either clicks (reward of +1) or does not click (reward of 0) and the feature vector describing the user is updated, with “T=10” is selected.

In this example, the reward signal is sparse such that if each action is selected with probability 0.5 always, about 0.48% of the transitions are rewarding, since users usually do not click on the advertisements. This means that most trajectories do not provide feedback. Also, whether a user clicks or not is close to random, so returns have relatively high variance. This results in high variance in gradient and natural gradient estimates.

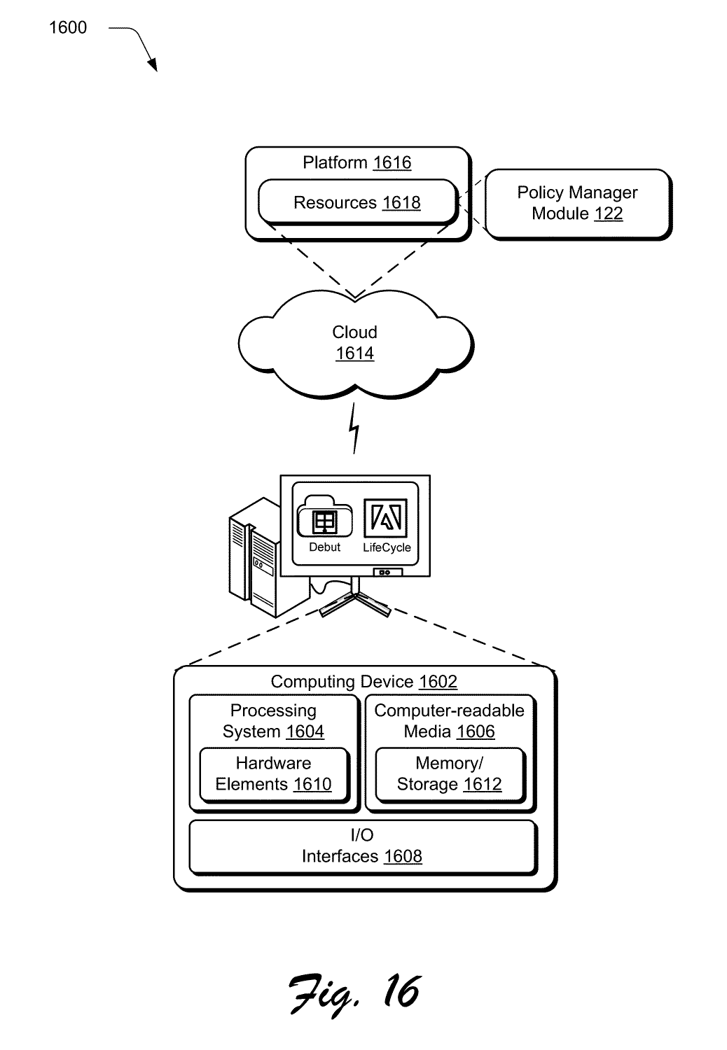

Algorithm 3 is applied to this domain using Softmax action selection with a third-order decoupled Fourier basis. A selection of “δ=0.05” is made, with “ƒₘᵢₙ=0.48,” and an initial policy is used that is slightly better than random. A value of “κ=100000” is selected based only on a priori runtime considerations in which no hyper-parameters are optimized. The results 1500 are provided in FIG. 15. The points are averaged over five trials and standard error bars are provided. In over 500,000 episodes (i.e., customer interactions), Algorithm 3 was able to safely increase the probability of clicks from 0.49% to 0.61%—a 24% improvement. This case study shows how Algorithm 3 can be used in a detailed simulation of a real-world application. Not only can it be deployed responsibly, due to its safety guarantee, but it achieves remarkable data efficiency that makes safe learning feasible on a practical timescale.

Example System and Device

FIG. 16 illustrates an example system generally at 1600 that includes an example computing device 1602 that is representative of one or more computing systems and/or devices that may implement the various techniques described herein. This is illustrated through inclusion of the policy manager module 122. The computing device 1602 may be, for example, a server of a service provider, a device associated with a client (e.g., a client device), an on-chip system, and/or any other suitable computing device or computing system.

The example computing device 1602 as illustrated includes a processing system 1604, one or more computer-readable media 1606, and one or more I/O interface 1608 that are communicatively coupled, one to another. Although not shown, the computing device 1602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1604 is representative of functionality to perform one or more operations using hardware. Accordingly, the processing system 1604 is illustrated as including hardware element 1610 that may be configured as processors, functional blocks, and so forth. This may include implementation in hardware as an application specific integrated circuit or other logic device formed using one or more semiconductors. The hardware elements 1610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1606 is illustrated as including memory/storage 1612. The memory/storage 1612 represents memory/storage capacity associated with one or more computer-readable media. The memory/storage component 1612 may include volatile media (such as random access memory (RAM)) and/or nonvolatile media (such as read only memory (ROM), Flash memory, optical disks, magnetic disks, and so forth). The memory/storage component 1612 may include fixed media (e.g., RAM, ROM, a fixed hard drive, and so on) as well as removable media (e.g., Flash memory, a removable hard drive, an optical disc, and so forth). The computer-readable media 1606 may be configured in a variety of other ways as further described below.

Input/output interface(s) 1608 are representative of functionality to allow a user to enter commands and information to computing device 1602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1610 and computer-readable media 1606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1610. The computing device 1602 may be configured to implement particular instructions and/or functions corresponding to the software and/or hardware modules. Accordingly, implementation of a module that is executable by the computing device 1602 as software may be achieved at least partially in hardware, e.g., through use of computer-readable storage media and/or hardware elements 1610 of the processing system 1604. The instructions and/or functions may be executable/operable by one or more articles of manufacture (for example, one or more computing devices 1602 and/or processing systems 1604) to implement techniques, modules, and examples described herein.

The techniques described herein may be supported by various configurations of the computing device 1602 and are not limited to the specific examples of the techniques described herein. This functionality may also be implemented all or in part through use of a distributed system, such as over a “cloud” 1614 via a platform 1618 as described below.

The cloud 1614 includes and/or is representative of a platform 1618 for resources 1616. The platform 1618 abstracts underlying functionality of hardware (e.g., servers) and software resources of the cloud 1614. The resources 1616 may include applications and/or data that can be utilized while computer processing is executed on servers that are remote from the computing device 1602. Resources 1616 can also include services provided over the Internet and/or through a subscriber network, such as a cellular or Wi-Fi network.

The platform 1618 may abstract resources and functions to connect the computing device 1602 with other computing devices. The platform 1618 may also serve to abstract scaling of resources to provide a corresponding level of scale to encountered demand for the resources 1616 that are implemented via the platform 1618. Accordingly, in an interconnected device embodiment, implementation of functionality described herein may be distributed throughout the system 1600. For example, the functionality may be implemented in part on the computing device 1602 as well as via the platform 1618 that abstracts the functionality of the cloud 1614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment for identifying and deploying potential digital advertising campaigns, where campaigns can be altered, removed, or replaced on demand, a method for optimizing campaign selection in the digital medium environment, the method comprising:
controlling replacement of one or more deployed polices of a content provider that are used to select advertisements with at least one of a plurality of policies, the controlling including:
searching a plurality of policies to locate the at least one said policy that is deemed safe to replace the one or more deployed policies, the at least one said policy deemed safe if a measure of performance of the at least one said policy is greater than a threshold measure of performance and within a defined level of confidence as indicated by one or more statistical guarantees computed through use of reinforcement learning and concentration inequalities on deployment data generated by the one or more deployed policies; and
responsive to the location of the at least one said policy that is deemed safe to replace the one or more other policies, causing the replacement of the one or more other policies with the at least one said policy.

2. A method as described in claim 1, wherein:
each of the plurality of policies is expressed using a high-dimensional vector; and
the searching includes computing a direction in a policy space that is expected to point towards a safe region.

3. A method as described in claim 2, wherein the searching is constrained to line searches of the high-dimensional vectors of the plurality of policies that correspond to the direction.

4. A method as described in claim 3, wherein the searching further comprises determining that the at least one said policy, of the plurality of policies having high-dimensional vectors corresponding to the direction, exhibits a highest level of the measure of performance, one to another.

5. A method as described in claim 2, wherein the direction is a generalized natural policy gradient.

6. A method as described in claim 1, wherein the one or more statistical guarantees are configured as performance bounds defined by the concentration inequality on the likely performance of the at least one said policy.

7. A method as described in claim 1, wherein the threshold is based at least in part on measured performance of the one or more deployed policies and a set margin.

8. A method as described in claim 7, wherein the threshold is set such that the estimated values of the at least one said policy exhibit an improvement in the measurement of performance over the one or more deployed policies.

9. A method as described in claim 1, wherein deployment data does not describe deployment of the at least one said policy.

10. A method as described in claim 1, wherein received deployment data also describes deployment of the at least one said policy.

11. A system comprising:
one or more computing devices configured to perform operations including selecting at least one of a plurality to policies to replace one or more deployed policies of a content provider that are used to select advertisements to be included with content, the selecting including:
accessing a plurality of high-dimensional vectors that express respective ones of the plurality of policies;
computing a direction in a policy space of the plurality of policies that is expected to point towards a region that is expected to be safe as including the policies that have a measure of performance that is greater than a threshold measure of performance and within a defined level of confidence; and
selecting the at least one said policy of the plurality of policies having high-dimensional vectors that correspond to the direction and that exhibits a highest level of the measure of performance.

12. A system as described in claim 11, wherein the selecting includes searching the plurality of policies as constrained to line searches of the high-dimensional vectors of the plurality of policies that correspond to the direction.

13. A system as described in claim 11, wherein the direction is a generalized natural policy gradient.

14. A system as described in claim 11, wherein the measure of performance is computed through use of reinforcement learning and concentration inequalities on deployment data generated by the one or more deployed policies.

15. A content provider comprising one or more computing devices configured to perform operations including:
deploying a policy to select advertisements to be included with content based on one or more characteristics associated with a request for the content; and
replacing the deployed policy with another policy that is selected from a plurality of policies by computing a direction in a policy space of a plurality of high-dimensional vectors of the plurality of policies that is expected to point towards a region that is expected to be safe as including the policies that have a measure of performance that is greater than a threshold measure of performance and within a defined level of confidence.

16. A system as described in claim 15, wherein the selecting includes searching the plurality of policies as constrained to line searches of the high-dimensional vectors of the plurality of policies that correspond to the direction.

17. A system as described in claim 15, wherein the direction is a generalized natural policy gradient.

18. A system as described in claim 15, wherein the measure of performance is computed through use of reinforcement learning and concentration inequalities on deployment data generated by the deployed policy.

19. A system as described in claim 18, wherein deployment data does not describe deployment of the other policy.

20. A system as described in claim 18, wherein the concentration inequality is configured to enforce performance bounds on the measurement of performance as part of the reinforcement learning.
